(19) United States
(12) Patent Application Publication
(10) Pub. No.: US 2014/0317335 A1
(43) Pub. Date: Oct. 23, 2014

(54) DATA STORAGE DEVICE, STORAGE CONTROLLER, AND DATA STORAGE CONTROL METHOD

(71) Applicant: Kabushiki Kaisha Toshiba, Minato-ku (JP)

(72) Inventors: Kazuhiro FUKUTOMI, Kanagawa (JP); Shinichi KANNO, Tokyo (JP)

(73) Assignee: Kabushiki Kaisha Toshiba, Minato-ku (JP)

(21) Appl. No.: 13/944,435

(22) Filed: Jul. 17, 2013

(30) Foreign Application Priority Data
Apr. 19, 2013 (JP) 2013-088412

(51) Int. Cl. G06F 3/06

(52) U.S. Cl. CPC G06F 3/0685; G06F 3/0619; G06F 3/0646
USPC 711/103

(57) ABSTRACT

According to one embodiment, a data storage device includes a first storage medium, a second nonvolatile storage medium, and a controller. The controller allows write data requested to be written from a host device to be recorded into the first storage medium which is a cache memory of the second storage medium according to a first recording method and allows read data that is read from the second storage medium to be recorded into the first storage medium according to a second recording method that provides lower reliability but larger memory capacity than the first recording method.

### CROSS-REFERENCE TO RELATED APPLICATIONS

This application is based upon and claims the benefit of priority from Japanese Patent Application No. 2013-088412, filed on Apr. 19, 2013; the entire contents of which are incorporated herein by reference.

### FIELD

Embodiments described herein relate generally to a data storage device, a storage controller, and a data storage control method.

### BACKGROUND

As a drive that realizes both large memory capacity and fast data access, a hybrid drive that uses semiconductor storage media such as a NAND flash memory as the cache of a storage such as a hard disk drive (HDD) is known.

### BRIEF DESCRIPTION OF THE DRAWINGS

FIG. 1 is a block diagram illustrating an overall configuration of a data storage device according to a first embodiment;

FIG. 2A is a diagram illustrating an overall configuration of a first address lookup table according to the first embodiment, and FIG. 2B is a diagram illustrating the content of cache address information that is registered in correspondence to the logical address of FIG. 2A;

FIG. 3A is a diagram illustrating an example of a first recording method of the data storage device according to the first embodiment, and FIG. 3B is a diagram illustrating an example of a second recording method of the data storage device according to the first embodiment;

FIG. 4A is a diagram illustrating another example of the first recording method of the data storage device according to the first embodiment, FIG. 4B is a diagram illustrating another example of the second recording method of the data storage device according to the first embodiment, and FIG. 4C is a diagram illustrating still another example of the second recording method of the data storage device according to the first embodiment;

FIG. 5A is a diagram illustrating still another example of the first recording method of the data storage device according to the first embodiment, FIG. 5B is a diagram illustrating still another example of the second recording method of the data storage device according to the first embodiment, FIG. 5C is a diagram illustrating still another example of the second recording method of the data storage device according to the first embodiment, and FIG. 5D is a diagram illustrating still another example of the second recording method of the data storage device of FIG. 1 according to the first embodiment;

FIG. 6A is a diagram illustrating still another example of the first recording method of the data storage device according to the first embodiment, FIG. 6B is a diagram illustrating still another example of the second recording method of the data storage device according to the first embodiment, and FIG. 6C is a diagram illustrating still another example of the second recording method of the data storage device according to the first embodiment;

FIG. 7 is a flowchart illustrating a write process of the data storage device according to the first embodiment;

FIG. 8 is a flowchart illustrating a read process of the data storage device according to the first embodiment;

FIG. 9 is a flowchart illustrating a flush process of the data storage device according to the first embodiment; and

FIG. 10 is a block diagram illustrating an overall configuration of a data storage device according to a second embodiment.

### DETAILED DESCRIPTION

In general, according to one embodiment, a data storage device includes a first storage medium, a second nonvolatile storage medium, and a controller. The controller allows write data requested to be written from a host device to be recorded into the first storage medium which is a cache memory of the second storage medium according to a first recording method and allows read data that is read from the second storage medium to be recorded into the first storage medium according to a second recording method that provides lower reliability but larger memory capacity than the first recording method.

Hereinafter, data storage devices according to embodiments will be described in detail with reference to the accompanying drawings. The present invention is not limited to these embodiments.

### First Embodiment

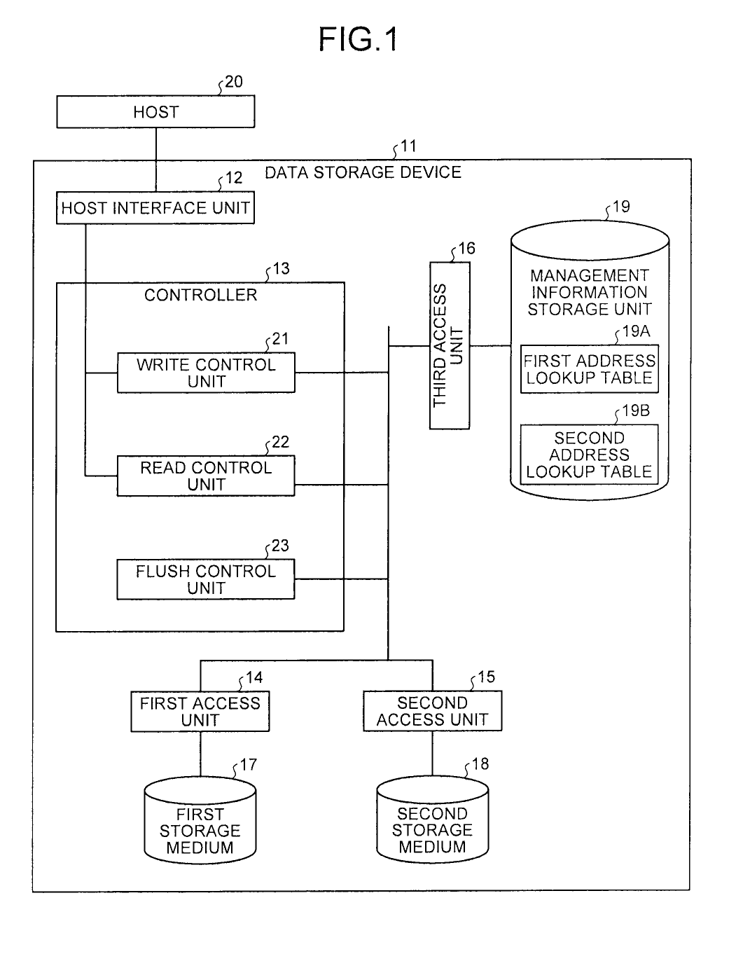

FIG. 1 is a block diagram illustrating an overall configuration of a data storage device according to a first embodiment.

In FIG. 1, a data storage device 11 includes a host interface unit 12, a controller 13, a first access unit 14, a second access unit 15, a third access unit 16, a first storage medium 17, a second nonvolatile storage medium 18, and a management information storage unit 19. In the first embodiment, the first storage medium 17 is used as a cache of the second storage medium 18. The first storage medium 17 preferably has a higher data access speed than the second storage medium 18. For example, a NAND flash memory can be used as the first storage medium 17, and a magnetic disk can be used as the second storage medium 18. The controller 13 includes a write control unit 21, a read control unit 22, and a flush control unit 23. The management information storage unit 19 includes a first address lookup table 19A and a second address lookup table 19B. The data storage device 11 is connected to a host 20 via the host interface unit 12.

The write control unit 21 can allow write data to be recorded into the first storage medium 17 according to a first recording method. The read control unit 22 can allow read data that is read from the second storage medium 18 to be recorded into the first storage medium 17 according to a second recording method that provides lower reliability but larger memory capacity than the first recording method.

Here, when the data storage device 11 receives a write command from the host 20, write data that is to be written according to the write command is not recorded in the second storage medium 18. Thus, a write cache can improve reliability of the first storage medium 17 by writing write data into the first storage medium 17 according to the first recording method. On the other hand, when the data storage device 11 receives a read command from the host 20, and data recorded in the second storage medium 18 is cached (written) into the first storage medium 17, the read data that is read according to the read command is recorded in both the first storage medium 17 and the second storage medium 18. Thus, even when the read data written in the first storage medium 17 is destroyed after the read data is recorded into the first storage medium 17, the read data can be read from the second storage medium 18 again. Thus, a read cache can increase memory capacity without decreasing reliability of the entire data storage device by recording write data into the first storage medium 17 according to the second recording method. As a result, it is possible to improve a cache hit ratio and to accelerate data access.

Hereinafter, the configuration and operation of FIG. 1 will be described in detail. In the following description, although a NAND flash memory is described as an example of the first storage medium 17 and a magnetic disk is described as an example of the second storage medium 18, the first storage medium 17 and the second storage medium 18 may be another nonvolatile memory and another storage medium. For example, the second storage medium 18 may be a NAND flash memory.

When the first storage medium 17 is a NAND flash memory, the first storage medium 17 has a plurality of blocks. A block is one of the units of data read and write processes like the units of an erase process of a NAND flash memory, for example. Moreover, a block has a plurality of pages. Serial page numbers are assigned to the respective pages of a block. Pages are the units of inputting and outputting data to and from the first storage medium 17, and a data amount of one page is referred to as a page size. The page size is determined to be 16 kilobytes (Kb), for example. For example, when a data management size of a cache is smaller than the page size, a plurality of items of cached data are included in one page. Specifically, for example, when a page size is 16 Kb and a data management size of a cache is 4 Kb, four items of cache data are included in one page.

The first access unit 14 receives a read instruction to read data from the first storage medium 17 as instructed from a requestor, reads read data corresponding to the read instruction from the first storage medium 17, and sends the read data to the requestor. Moreover, the first access unit 14 receives a write instruction to write data to the first storage medium 17 as instructed from the requestor, inputs write data corresponding to the write instruction to the first storage medium 17, and executes a write process.

When the second storage medium 18 is a magnetic disk, the second storage medium 18 has a plurality of concentric tracks. A track includes a plurality of sectors. Serial sector numbers are assigned to the respective sectors. The sectors are the units of inputting and outputting data between the data storage device 11 and the host 20. Data of a target sector can be read and written by rotating the second storage medium 18 about a rotation axis and moving a magnetic head in an inter-track direction in relation to the second storage medium 18 that is rotating.

The second access unit 15 receives a read instruction to read data from the second storage medium 18 as instructed from a requestor, reads read data corresponding to the read instruction from the second storage medium 18, and sends the read data to the requestor. Moreover, the second access unit 15 receives a write instruction to write data to the second storage medium 18 as instructed from the requestor, inputs write data corresponding to the write instruction to the second storage medium 18, and executes a write process.

The management information storage unit 19 stores management information of the data recorded to the first storage medium 17 and the second storage medium 18. The management information includes the first address lookup table 19A and the second address lookup table 19B.

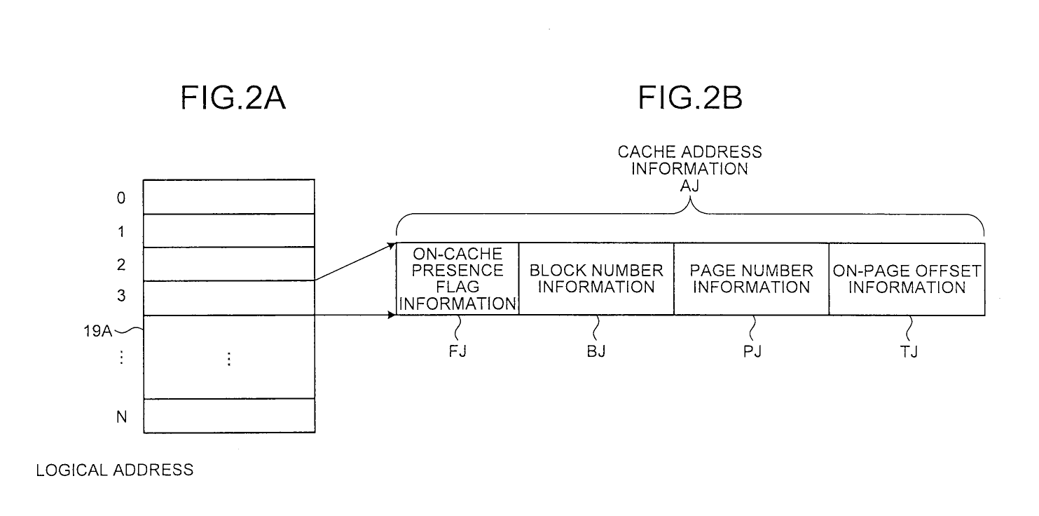

Here, a configuration example of the first address lookup table 19A will be described with reference to FIGS. 2A and 2B. FIG. 2A is a diagram illustrating an overall configuration of the first address lookup table according to the first embodiment, and FIG. 2B is a diagram illustrating the content of cache address information registered in correspondence to a logical address of FIG. 2A.

In FIG. 2A, the first address lookup table 19A manages the mapping between logical addresses 0, 1, . . . , and N (where N is a positive integer) which are cache management units, and cache address information AJ includes information indicating whether the data of a logical address is cached in the first storage medium 17 and the position information of the data on the first storage medium 17 when the data of the logical address is included in the first storage medium 17 as cache data. The cache management units are defined to be 4 Kb, for example. The cache address information AJ includes on-cache presence flag information FJ, block number information BJ, page number information PJ, and on-page offset information TJ. When the first storage medium 17 is another nonvolatile memory rather than the NAND flash memory, the block number information BJ, the page number information PJ, and the on-page offset information TJ may be replaced with information corresponding to the structure of the nonvolatile memory.

The on-cache presence flag information FJ is information indicating whether the data of a corresponding logical address is cached in the first storage medium 17. The information indicated by the on-cache presence flag information FJ includes at least three types of information: information indicating whether the data is cached as a read cache, information indicating whether the data is cached as a write cache, and information indicating that the data is not cached. The block number information BJ is information indicating a block in which an area where the data of the corresponding logical address is stored is included when the data is cached. The page number information PJ is information indicating a page in which an area where the data of the corresponding logical address is stored is included when the data is cached. The on-page offset information TJ is information indicating a position on a page at which an area where the data of the corresponding logical address is stored is located when the data is cached. In the present embodiment, it is assumed that, when the cache management units are smaller than the page size, one page includes a plurality of cached data.

The second address lookup table 19B manages the mapping between storage device address information which is the address information that the data storage device 11 provides to the host 20, and second storage medium physical address information which is information indicating a position on the second storage medium 18 at which the data of the storage device address is stored. For example, a logical block address (LBA) is an embodiment of the storage device address in HDD and SSD. A data size specified by LBA is defined to be 512 bytes, for example. The second storage medium physical address information includes track number information and sector number information. The track number information is information indicating a track in which the data of the corresponding storage device address is included. The sector number information is information indicating a sector in which the data of the corresponding storage device address is included.

When the physical addresses of the second storage medium 18 are fixedly correlated with the storage device addresses, and the correspondence can be calculated by computation or the like, the second address lookup table 19B may be omitted. In the present embodiment, it is assumed that the second address lookup table 19B is not omitted.

The management information may include additional information that can be derived from the first address lookup table 19A and the second address lookup table 19B in order to simplify subsequent various processes. Moreover, in order to simplify the subsequent various processes, the information that can be derived from the first address lookup table 19A and the second address lookup table 19B may be used.

Here, returning to FIG. 1, the third access unit 16 receives a read instruction to read data from the management information storage unit 19 as instructed from a requestor, reads management information stored in the management information storage unit 19 corresponding to the read instruction from the management information storage unit 19, and sends the management information to the requestor. Moreover, the third access unit 16 receives a write instruction to write data to the management information storage unit 19 as instructed from the requestor, inputs the management information corresponding to the write instruction to the management information storage unit 19, and executes a write process.

The host interface unit 12 receives a command including a write command and a read command from the host 20. The write command includes storage device address information and write data. The read command includes storage device address information.

As described above, the data size specified by the storage device address is defined to be 512 bytes, for example, and the data size specified by the logical address is defined to be 4 Kb. Thus, although the data size specified by the storage device address is generally different from the data size specified by the logical address, the storage device address and the logical address can be converted from each other. For example, when the storage device address information is allocated every 512 bytes and the logical address information is allocated every 4 Kb, the storage device address information can be converted into the logical address information by obtaining a quotient when the storage device address information is divided by 8. In the present embodiment, in order to simplify the description, although a configuration where the data size specified by the storage device address is the same as the data size specified by the logical address is described, the present invention can be applied to a configuration where the data size specified by the storage device address is different from the data size specified by the logical address.

The host interface unit 12 sends a write command to the write control unit 21 when a received command is a write command and sends a read command to the read control unit 22 when the received command is a read command. Upon receiving data from the read control unit 22, the host interface unit 12 sends the received data to the host 20.

Upon receiving a write command from the host interface unit 12, the write control unit 21 extracts storage device address information and write data from the received write command. The write control unit 21 determines whether the extracted write data is to be cached to the first storage medium 17. Any known method can be used for this determination.

When it is determined that the extracted write data is not to be cached into the first storage medium 17, the write control unit 21 instructs the third access unit 16 to acquire the track number information and the sector number information of the second storage medium 18 serving as a write destination of the extracted write data from the second address lookup table 19B. Any known method can be used for the method of deriving the track number information and the sector number information serving as the write destination of the write data from the second address lookup table 19B. The write control unit 21 acquires the track number information and the sector number information serving as the write destination of the extracted write data from the third access unit 16. When the second storage medium 18 is another storage medium rather than the magnetic disk, the track number information and the sector number information may be replaced with information corresponding to the structure of the storage medium.

The write control unit 21 instructs the second access unit 15 to write the extracted write data to an area corresponding to the track number information and the sector number information of the second storage medium 18. The write control unit 21 instructs the third access unit 16 to write the acquired track number information and sector number information to the second storage medium physical address information corresponding to the storage device address information of the second address lookup table 19B. This is to update the second storage medium physical address information indicating the position at which the write data is written in response to the present write command because the second storage medium physical address information corresponding to the storage device address information of the second address lookup table 19B before the present write command is received may be different from the second storage medium physical address information indicating the position at which the write data is written in response to the present write command. When the second storage medium physical address information corresponding to the storage device address information of the second address lookup table 19B before the present write command is received is the same as the second storage medium physical address information indicating the position at which the write data is written in response to the present write command, it is not necessary to update the second storage medium physical address information indicating the position at which the write data is written in response to the present write command.

On the other hand, when it is determined that the extracted write data is to be cached into the first storage medium 17, the write control unit 21 instructs the third access unit 16 to acquire the block number information BJ, the page number information PJ, and the on-page offset information TJ (hereinafter, these three items of information will be referred to as cache destination information) serving as a write destination of the extracted write data from the first address lookup table 19A. Any method can be used for a method of deriving the cache destination information serving as the write destination of the write data from the first address lookup table 19A. The write control unit 21 acquires the cache destination information serving as the write destination of the extracted write data from the third access unit 16.

The write control unit 21 instructs the first access unit 14 to write the write data in an area corresponding to the cache destination information of the first storage medium 17 according to the first recording method. For example, when the cache management units of the present embodiment are smaller than the page size, a plurality of items of cache data is included in one page. However, in this case, a plurality of items of cache data corresponding to the size of one page may be controlled to be written together to the first storage medium 17.

The write control unit 21 instructs the third access unit 16 so that the cache address information AJ corresponding to the logical address that is converted from the storage device address information extracted from the write command indicates the write destination of the write data. More specifically, the write control unit 21 updates the cache destination information of the cache address information AJ of the management information storage unit 19 with the cache destination information acquired from the third access unit 16 and updates the on-cache presence flag information FJ with the information indicating that the data is present as a write cache. This is to update the cache destination information indicating the position at which the write data is written in response to the present write command because the cache destination information corresponding to the logical address of the first address lookup table 19A before the present write command is received may be different from the cache destination information indicating the position at which the write data is written in response to the present write command. When the cache destination information corresponding to the logical address of the first address lookup table 19A before the present write command is received is the same as the cache destination information indicating the position at which the write data is written in response to the present write command, it is not necessary to update the cache destination information indicating the position at which the write data is written in response to the present write command.

Upon receiving a read command from the host interface unit 12, the read control unit 22 extracts storage device address information from the received read command. The read control unit 22 converts the extracted storage device address information into logical address information. The read control unit 22 instructs the third access unit 16 to read the on-cache presence flag information FJ corresponding to the converted logical address information from the management information storage unit 19 (the first address lookup table 19A). The read control unit 22 acquires the on-cache presence flag information FJ.

The read control unit 22 determines whether the data corresponding to the converted logical address is present on a cache from the acquired on-cache presence flag information FJ. When it is determined that the data corresponding to the converted logical address is present on the cache, the read control unit 22 instructs the third access unit 16 to read the cache destination information corresponding to the converted logical address information from the management information storage unit 19 (the first address lookup table 19A). The read control unit 22 acquires the cache destination information.

Moreover, the read control unit 22 determines whether the data corresponding to the converted logical address is present on a write cache or on a read cache from the acquired on-cache presence flag information FJ. When it is determined that the data corresponding to the logical address is present on the write cache, the read control unit 22 instructs the first access unit 14 to read data from an area of the first storage medium 17 indicated by the acquired cache destination information according to a method of reading data recorded according to the first recording method. The read control unit 22 acquires the read data.

On the other hand, when it is determined that the data corresponding to the logical address is present on the read cache, the read control unit 22 instructs the first access unit 14 to read data from an area of the first storage medium 17 indicated by the acquired cache destination information according to a method of reading data recorded according to the second recording method. The read control unit 22 acquires the read data. The second recording method will be described later.

When it is determined that the data corresponding to the logical address is not present on the cache, the read control unit 22 instructs the third access unit 16 to read the track number information and the sector number information which are the second storage medium physical address information corresponding to the extracted storage device address information from the management information storage unit 19 (the second address lookup table 19B). The read control unit 22 acquires the track number information and the sector number information through the third access unit 16.

The read control unit 22 instructs the second access unit 15 to read data from an area of the second storage medium 18 indicated by the acquired track number information and sector number information. The read control unit 22 acquires the read data through the second access unit 15.

The read control unit 22 determines whether the read data is to be read-cached into the first storage medium 17. Any method can be used for this determination.

When it is determined that the read data is not to be read-cached into the first storage medium 17, the read control unit 22 may instruct the third access unit 16 to update the management information stored in the management information storage unit 19 in order to update a data hit ratio or the like as necessary. For example, by storing data hit ratio information in the management information, it is possible to take measures such as to leave data having a high hit ratio without flushing the same from the cache in a flush process described later.

When it is determined that the read data is to be read-cached into the first storage medium 17, the read control unit 22 instructs the third access unit 16 to acquire the cache destination information of the logical address corresponding to the write destination of the data read from the second storage medium 18 from the first address lookup table 19A. Any method can be used for a method of deriving the cache destination information serving as the write destination of the read data from the first address lookup table 19A. The read control unit 22 acquires the cache destination information serving as the write destination of the data read from the second storage medium 18 from the third access unit 16.

The read control unit 22 instructs the first access unit 14 to write the data read from the second storage medium 18 in an area of the first storage medium 17 corresponding to the acquired cache destination information according to the second recording method. For example, when the cache management units of the present embodiment are smaller than the page size, a plurality of items of cache data is included in one page. However, in this case, a plurality of items of cache data corresponding to the size of one page may be controlled to be written together to the first storage medium 17.

The read control unit 22 instructs the third access unit 16 so that the cache address information AJ corresponding to the converted logical address indicates the write destination of the data read from the second storage medium 18. More specifically, the read control unit 22 updates the cache destination information of the cache address information AJ of the management information storage unit 19 with the cache destination information acquired from the third access unit 16 and updates the on-cache presence flag information FJ with the information indicating that the data is present as a read cache. This is because, when the data corresponding to the logical address of the first address lookup table 19A is cached in the past and is later flushed from the cache by the flush process described later, the cache destination information which is the record destination of the data cached in the past is sometimes recorded in the logical address of the first address lookup table 19A. Here, since the cache destination information corresponding to the logical address of the first address lookup table 19A before the present read command is received may be different from the cache destination information indicating the position at which the read data is written in response to the present read command, the cache destination information indicating the position at which the read data is written in response to the present read command is updated. When the cache destination information corresponding to the logical address of the first address lookup table 19A before the present read command is received is the same as the cache destination information indicating the position at which the read data is written in response to the present read command, it is not necessary to update the cache destination information indicating the position at which the read data is written in response to the present read command. The read control unit 22 may instruct the third access unit 16 to update the management information stored in the management information storage unit 19 in order to update a data hit ratio or the like as necessary. For example, by storing data hit ratio information in the management information, it is possible to take measures such as to leave data having a high hit ratio without flushing the same from the cache in the flush process described later.

The read control unit 22 sends the data read from the first storage medium 17 or the data read from the second storage medium 18 to the host interface unit 12. The read control unit 22 may send the read data to the host interface unit 12 immediately after reading data from the first storage medium 17 or the second storage medium 18. In this manner, it is possible to accelerate a response time to the read command for the host 20.

The flush control unit 23 determines whether data to be flushed from the cache is present at a predetermined timing or a dynamically determined timing. If data is sequentially cached (written) into the first storage medium 17, finally, a case where additional data cannot be cached (written) into the first storage medium 17 may occur. For example, in such a case, a process of invalidating the data that is cached (written) into the first storage medium 17 in the past and securing an area for a new write destination (a process of flushing data from the cache) is required. The timing of flushing data from the cache is not limited to the above. Any known timing can be used as this timing. Moreover, any known method can be used for this determination.

The flush control unit 23 ends the process when it is determined that the data to be flushed from the cache is not present. When it is determined that the data to be flushed from the cache is present, the flush control unit 23 determines whether the flush target data is read cache data or write cache data.

When it is determined that the flush target data is read cache data, the flush control unit 23 updates the management information. More specifically, the flush control unit 23 instructs the third access unit 16 to update the on-cache presence flag information FJ of the first address lookup table 19A corresponding to the flush target data with the information indicating that the data is not present as a cache.

When it is determined that the flush target data is write cache data, the flush control unit 23 copies the data into the second storage medium 18. More specifically, the flush control unit 23 instructs the third access unit 16 to read the cache destination information corresponding to the flush target data. The flush control unit 23 acquires the cache destination information. The flush control unit 23 instructs the first access unit 14 to read data from an area of the first storage medium 17 indicated by the acquired cache destination information according to a method of reading data recorded according to the first recording method. The flush control unit 23 acquires the read data.

The flush control unit 23 instructs the third access unit 16 to acquire the track number information and the sector number information of the second storage medium 18 serving as the write destination of the read data from the second address lookup table 19B. Any known method can be used for a method of deriving the track number information and the sector number information serving as the write destination of the read data from the second address lookup table 19B. The flush control unit 23 acquires the track number information and the sector number information serving as the write destination of the read data from the third access unit 16.

The flush control unit 23 instructs the second access unit 15 to write the read data into an area of the second storage medium 18 corresponding to the acquired track number information and the sector number information. The flush control unit 23 updates the management information. More specifically, the flush control unit 23 instructs the third access unit 16 to write the acquired track number information and sector number information into the second storage medium physical address information that corresponds to the storage device address information on the second address lookup table 19B corresponding to the flush target data. This is to update the second storage medium physical address information indicating the position at which the data is written according to the present flush process because the second storage medium physical address information corresponding to the storage device address information of the second address lookup table 19B before the present flush process is performed may be different from the second storage medium physical address information indicating the position at which the data is written according to the present flush process. When the second storage medium physical address information corresponding to the storage device address information of the second address lookup table 19B before the present flush process is performed is the same as the second storage medium physical address information indicating the position at which the data is written according to the present flush process, it is not necessary to update the second storage medium physical address information indicating the position at which the data is written according to the present flush process.

Moreover, the flush control unit 23 updates the on-cache presence flag information FJ corresponding to the flush target data with the information indicating that data is not present as a cache. The on-cache presence flag information FJ may be updated with information indicating that data is present as a read cache rather than updating with the information indicating that data is not present as a cache. By doing so, the data can be used as a read cache without invalidating the data that is recorded on the first storage medium 17 as a write cache.

Hereinafter, the first and second recording methods for the first storage medium 17 will be described.

The first and second recording methods are adopted such that the reliability of data recorded according to the first recording method is higher than the reliability of data recorded according to the second recording method. Moreover, the recording methods are adopted such that the volume of data that can be recorded according to the second recording method is larger than the volume of data that can be recorded according to the first recording method. Any recording method can be used as the first and second recording methods as long as the method satisfies these conditions.

In writing of data to a write cache, the first recording method that provides higher data reliability than the second recording method is applied. By doing so, since the data reliability of the write cache can be secured, the reliability of the data storage device 11 is not impaired. On the other hand, in recording of data to a read cache, the second recording method that can write a larger volume of data than the first recording method is applied. By doing so, since the volume of data that can be recorded into the read cache can be increased, a higher cache hit ratio can be obtained. Even when read cache data is corrupted when recording data into the read cache, since the original read cache data is present on the second storage medium 18, it is possible to read the data from the second storage medium 18 again. In this manner, the data storage device 11 capable of improving reliability during storing of data while realizing both large memory capacity and fast data access can be realized at a low cost.

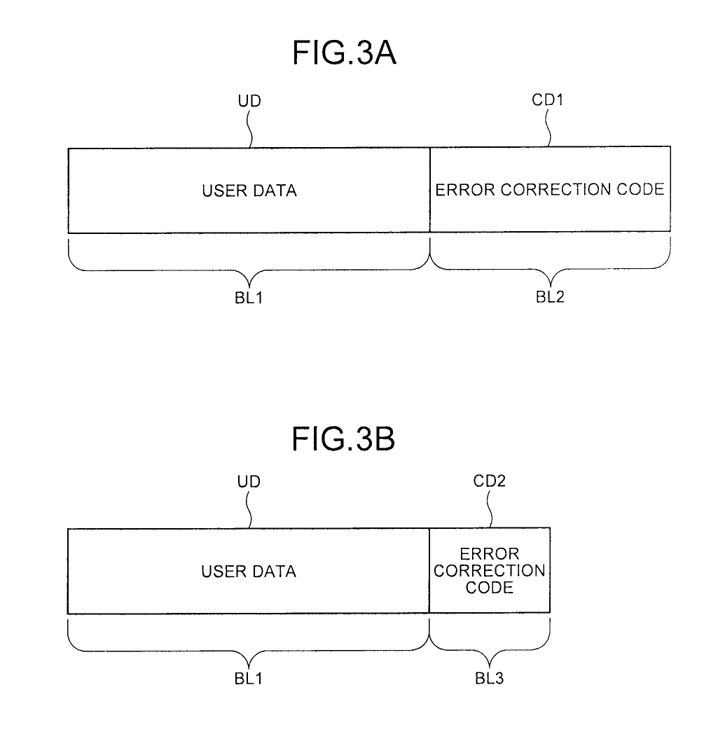

FIG. 3A is a diagram illustrating an example of the first recording method of the data storage device according to the first embodiment, and FIG. 3B is a diagram illustrating an example of the second recording method of the data storage device according to the first embodiment.

In FIGS. 3A and 3B, the first recording method allocates an error correction code (ECC) CD1 having a larger bit length BL2 than the second recording method to user data UD having the same data length of a bit length BL1. On the other hand, the second recording method allocates an error correction code (ECC) CD2 having a smaller bit length BL3 than the first recording method.

In general, the larger the bit length allocated to an error correction code (ECC), the better the error correction performance is improved. Thus, the reliability of the data recorded according to the first recording method is higher than the reliability of the data recorded according to the second recording method.

Moreover, since the first storage medium 17 has predetermined memory capacity, the smaller the amount of the error correction code (ECC) written together with the user data, the larger the amount of user data can be recorded. Thus, the volume of the data that can be recorded according to the second recording method is larger than the volume of the data that can be written according to the first recording method.

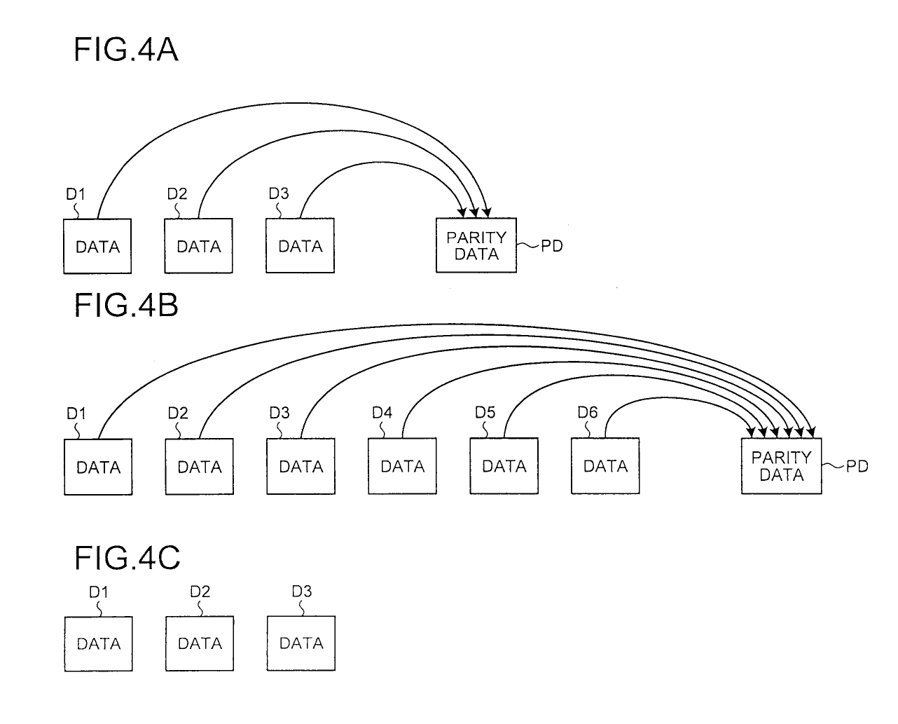

FIG. 4A is a diagram illustrating another example of the first recording method of the data storage device according to the first embodiment, FIG. 4B is a diagram illustrating another example of the second recording method of the data storage device according to the first embodiment, and FIG. 4C is a diagram illustrating still another example of the second recording method of the data storage device according to the first embodiment.

In FIG. 4A, when parity data PD is generated from a plurality of items of data, the number of items of data D1 to D6 serving as the source of generation of the parity data PD in the second recording method as illustrated in FIG. 4B is set to be larger than the number of items of data D1 to D3 serving as the source of generation of the parity data PD in the first recording method. Alternatively, in the second recording method, the parity data PD may not be added to the data D1 to D3 as illustrated in FIG. 4C.

In general, the smaller the number of items of data serving as the source of generation of the parity data PD, the better the error correction performance is improved. Thus, the reliability of the data written according to the first writing method is higher than the reliability of the data written according to the second writing method.

Moreover, since the first storage medium 17 has predetermined memory capacity, the larger the number of items of data serving as the source of generation of the parity data PD, the smaller the amount of the parity data becomes and the larger the amount of user data can be recorded. Thus, the volume of the data that can be recorded according to the second recording method is larger than the volume of the data that can be recorded according to the first recording method.

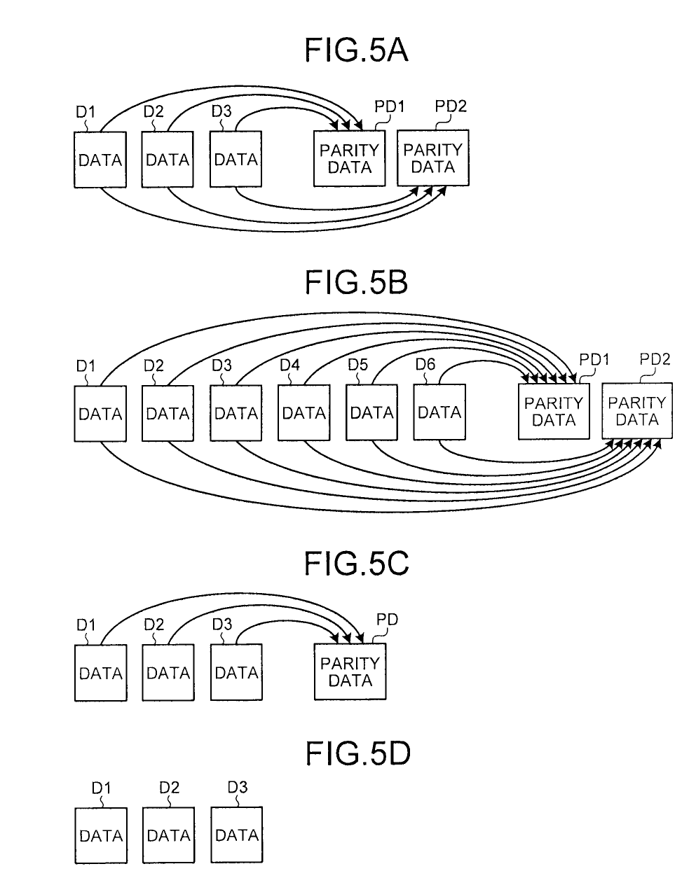

FIG. 5A is a diagram illustrating still another example of the first recording method of the data storage device according to the first embodiment, FIG. 5B is a diagram illustrating still another example of the second recording method of the data storage device according to the first embodiment, FIG. 5C is a diagram illustrating still another example of the second recording method of the data storage device according to the first embodiment, and FIG. 5D is a diagram illustrating still another example of the second recording method of the data storage device according to the first embodiment.

In FIG. 5A, when Reed-Solomon (RS) code parity data PD1 and PD2 are generated from a plurality of items of data, the number of items of data D1 to D6 serving as the source of generation of the RS code parity data PD1 and PD2 in the second recording method as illustrated in FIG. 5B is set to be larger than the number of items of data D1 to D3 serving as the source of generation of the RS code parity data PD1 and PD2 in the first recording method.

In general, the smaller the number of items of data serving as the source of generation of the RS code parity data PD1 and PD2, the better the error correction performance is improved. Thus, the reliability of the data recorded according to the first recording method is higher than the reliability of the data recorded according to the second recording method.

Moreover, since the first storage medium 17 has predetermined memory capacity, the larger the number of items of data serving as the source of generation of the RS code parity data PD1 and PD2, the smaller the amount of the parity data becomes and the larger the amount of user data can be recorded. Thus, the volume of the data that can be recorded according to the second recording method is larger than the volume of the data that can be recorded according to the first recording method.

Alternatively, although error correction performance is poorer than RS codes, an error correction method that uses a smaller amount of error correction code (ECC) may be adopted. For example, as illustrated in FIG. 5C, in the second recording method, parity data PD of the parity scheme illustrated in FIGS. 4A to 4C may be added to the data D1 to D3. This is because, although a RS code can correct up to two errors of data, since the parity scheme can correct only one error of data, the parity scheme provides poorer error correction performance than the RS codes. On the other hand, when the number of items of data serving as the source of generation of parity data is the same, the parity scheme can decrease the amount of parity data more than the RS codes, and a larger amount of user data can be recorded. Thus, the volume of the data that can be recorded according to the second recording method is larger than the volume of the data that can be recorded according to the first recording method. Alternatively, in the second recording method, as illustrated in FIG. 5D, the RS code parity data PD1 and PD2 may not be added to the data D1 to D3.

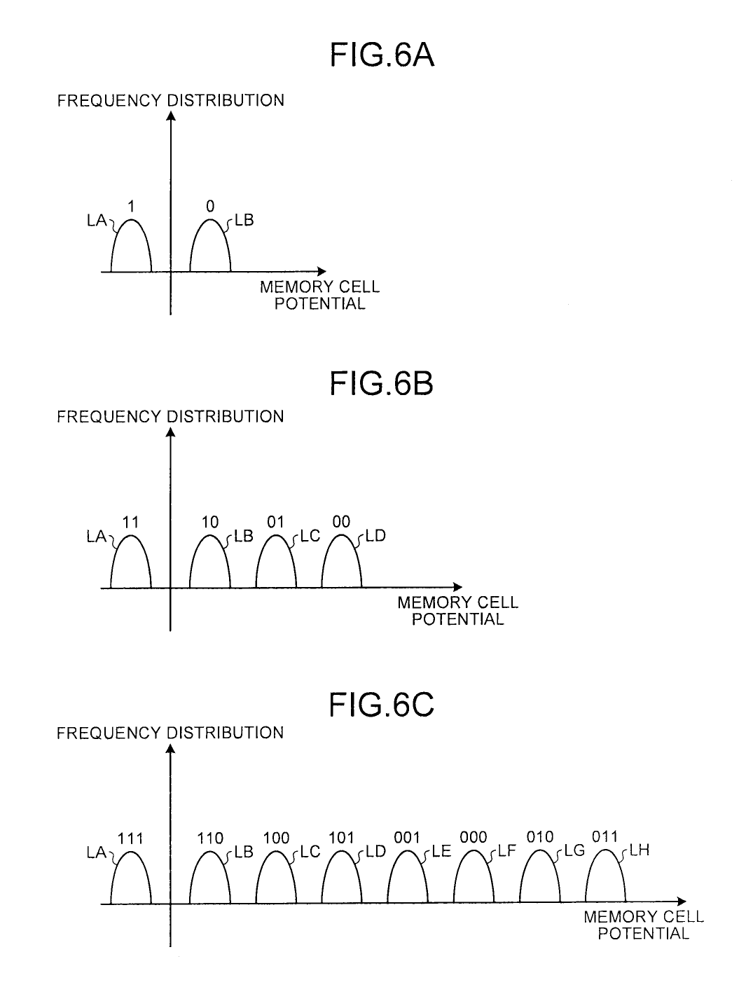

FIG. 6A is a diagram illustrating still another example of the first recording method of the data storage device according to the first embodiment, FIG. 6B is a diagram illustrating still another example of the second recording method of the data storage device according to the first embodiment, and FIG. 6C is a diagram illustrating still another example of the second recording method of the data storage device according to the first embodiment.

In FIG. 6A, the first recording method is a 1-bit/cell recording method. In the 1-bit/cell recording method, a potential distribution during reading from a memory cell is set to LA or LB. That is, 1-bit/cell can be realized by allocating “1” to a potential distribution LA and “0” to a potential distribution LB. In contrast, the second writing method is a 2-bit/cell recording method as illustrated in FIG. 6B. In the 2-bit/cell recording method, a potential distribution during reading from a memory cell is set to LA to LD. That is, 2-bit/cell can be realized by allocating “11” to a potential distribution LA, “10” to a potential distribution LB, “01” to a potential distribution LC, and “00” to a potential distribution LD. Alternatively, the second recording method may adopt a 3-bit/cell recording method as illustrated in FIG. 6C. In the 3-bit/cell recording method, a potential distribution during reading from a memory cell is set to LA to LH. That is, 3-bit/cell can be realized by allocating “111” to a potential distribution LA, “110” to a potential distribution LB, “100” to a potential distribution LC, “101” to a potential distribution LD, “001” to a potential distribution LE, “000” to a potential distribution LF, “010” to a potential distribution LG, “011” to a potential distribution LH.

In general, since the smaller the number of bits stored per memory cell, the wider the range of threshold values is set, the reliability of recorded data is high. Thus, the reliability of the data recorded according to the first recording method is higher than the reliability of the data recorded according to the second recording method.

Moreover, since the total number of memory cells of the first storage medium 17 is a predetermined number, the larger the number of bits recorded per memory cell, the larger the amount of user data can be recorded. Thus, the volume of the data that can be recorded according to the second recording method is larger than the volume of the data that can be recorded according to the first recording method.

Alternatively, a 2-bit/cell recording method may be adopted as the first recording method, and a 3-bit/cell recording method may be adopted as the second recording method. Moreover, the recording methods of the above-described specific examples may be combined in any manner.

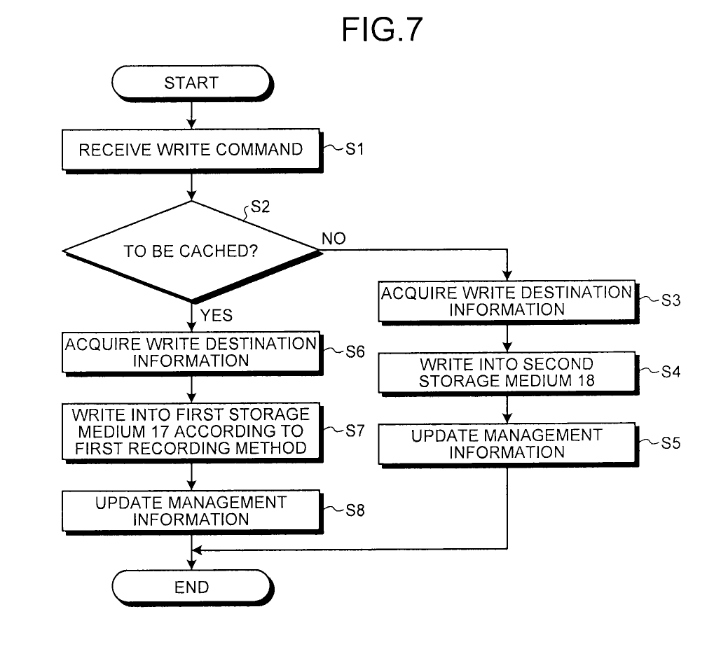

FIG. 7 is a flowchart illustrating a write process of the data storage device according to the first embodiment.

In FIG. 7, in step S1, the host interface unit 12 receives a command including a write command or a read command from the host 20. When the received command is a write command, the received write command is sent to the write control unit 21.

Upon receiving a write command from the host interface unit 12, the write control unit 21 extracts storage device address information and write data from the received write command.

In step S2, the write control unit 21 determines whether the extracted write data is to be cached into the first storage medium 17. When it is determined that the write data is not to be cached (No in step S2), the flow proceeds to step S3. In step S3, the write control unit 21 instructs the third access unit 16 to acquire (read) the track number information and the sector number information serving as the write destination of the extracted write data from the second address lookup table 19B. The third access unit 16 reads the instructed information from the information stored in the management information storage unit 19 and sends the read information to the write control unit 21. The write control unit 21 acquires the track number information and the sector number information of the second storage medium 18 serving as the write destination of the extracted write data from the third access unit 16.

In step S4, the write control unit 21 instructs the second access unit 15 to write the extracted write data in an area of the second storage medium corresponding to the acquired track number information and sector number information. The second access unit 15 writes the instructed data in the instructed area of the second storage medium 18.

In step S5, the write control unit 21 instructs the third access unit 16 to write the acquired track number information and sector number information in the second storage medium physical address information corresponding to the extracted storage device address information. The third access unit 16 writes the instructed information in an area that is instructed by the information stored in the management information storage unit 19.

On the other hand, when it is determined that the write data is to be cached (Yes in step S2), the flow proceeds to step S6. In step S6, the write control unit 21 instructs the third access unit 16 to acquire the cache destination information serving as the write destination of the extracted write data from the first address lookup table 19A. The third access unit 16 reads the instructed information from the information stored in the management information storage unit 19 and sends the read information to the write control unit 21. The write control unit 21 acquires the cache destination information serving as the write destination of the extracted write data from the third access unit 16.

In step S7, the write control unit 21 instructs the first access unit 14 to write the extracted write data in an area of the first storage medium 17 corresponding to the acquired cache destination information according to the first recording method. The first access unit 14 writes the instructed data in the instructed area of the first storage medium 17 according to the first recording method.

In step S8, the write control unit 21 instructs the third access unit 16 so that the cache address information corresponding to the logical address converted from the extracted storage device address information indicates the write destination of the write data. The third access unit 16 writes the instructed information in an area that is instructed by the information stored in the management information storage unit 19.

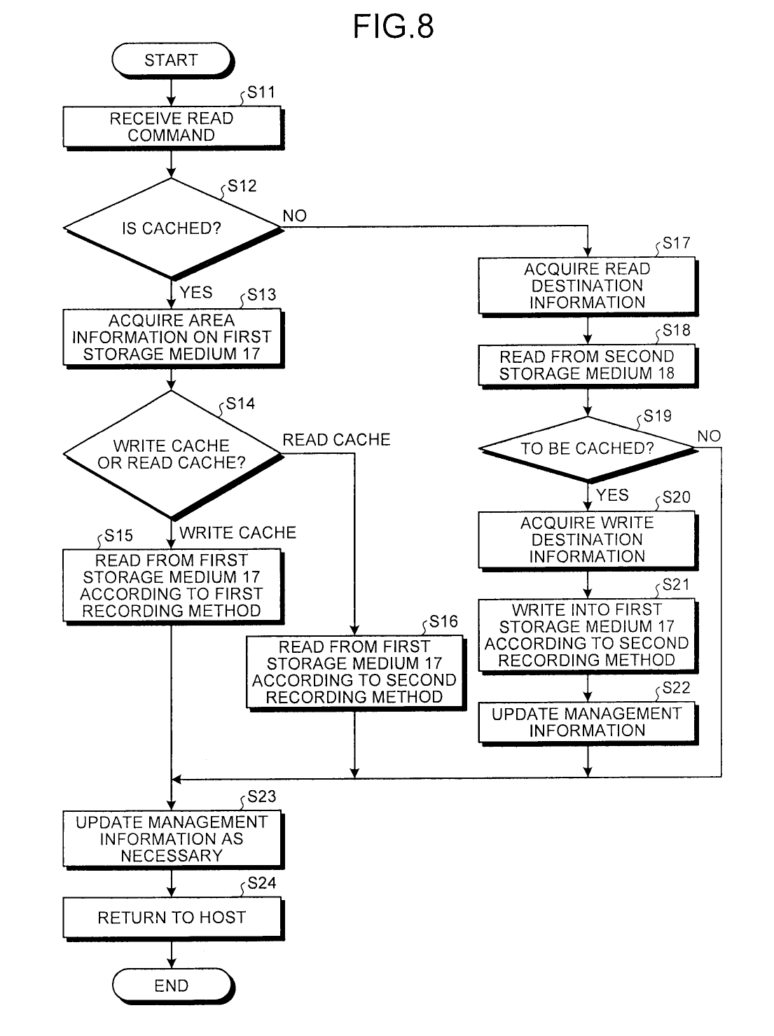

FIG. 8 is a flowchart illustrating a read process of the data storage device according to the first embodiment.

In FIG. 8, in step S11, the host interface unit 12 receives a command including a write command or a read command from the host 20. When the received command is a read command, the host interface unit 12 sends the received read command to the read control unit 22.

Upon receiving the read command from the host interface unit 12, the read control unit 22 extracts storage device address information from the received read command. The read control unit 22 converts the extracted storage device address information into logical address information.

The read control unit 22 instructs the third access unit 16 to read the on-cache presence flag information FJ corresponding to the converted logical address information. The third access unit 16 reads the instructed information from the information stored in the management information storage unit 19 and sends the read information to the read control unit 22. The read control unit 22 acquires the on-cache presence flag information FJ.

In step S12, the read control unit 22 determines whether the data corresponding to the converted logical address is cached based on the acquired on-cache presence flag information FJ.

When the data corresponding to the logical address is cached (Yes in step S12), the flow proceeds to step S13. In step S13, the read control unit 22 instructs the third access unit 16 to read the cache destination information corresponding to the converted logical address information. The third access unit 16 reads the instructed information from the information stored in the management information storage unit 19 and sends the read information to the read control unit 22. The read control unit 22 acquires the cache destination information.

In step S14, the read control unit 22 determines whether the data corresponding to the converted logical address is write-cached or read-cached based on the acquired on-cache presence flag information FJ.

When it is determined in step S14 that the data is write-cached, the flow proceeds to step S15. In step S15, the read control unit 22 instructs the first access unit 14 to read data from an area indicated by the acquired cache destination information according to a method of reading data recorded according to the first recording method. The first access unit 14 reads the instructed data from the instructed area of the first storage medium 17 according to the method of reading data recorded according to the first recording method and sends the read data to the read control unit 22. The read control unit 22 acquires the read data and the flow proceeds to step S23.

When it is determined in step S14 that the data is read-cached, the flow proceeds to step S16. In step S16, the read control unit 22 instructs the first access unit 14 to read data from an area indicated by the acquired cache destination information according to a method of reading data recorded according to the second recording method. The first access unit 14 reads the instructed data from the instructed area of the first storage medium 17 according to the method of reading data written according to the second recording method and sends the read data to the read control unit 22. The read control unit 22 acquires the read data and the flow proceeds to step S23.

When the data corresponding to the logical address is not cached (No in step S12), the flow proceeds to step S17. In step S17, the read control unit 22 instructs the third access unit 16 to read the track number information and the sector number information which are the second storage medium physical address information corresponding to the extracted storage device address information. The third access unit 16 reads the instructed information from the information stored in the management information storage unit 19 and sends the read information to the read control unit 22. The read control unit 22 acquires the track number information and the sector number information.

In step S18, the read control unit 22 instructs the second access unit 15 to read data from an area indicated by the acquired track number information and sector number information. The second access unit 15 reads the instructed data from the instructed area of the second storage medium 18 and sends the read data to the read control unit 22. The read control unit 22 acquires the read data.

In step S19, the read control unit 22 determines whether the read data is to be read-cached into the first storage medium 17. When it is determined that the data is not to be read-cached (No in step S19), the flow proceeds to step S23.

When it is determined that the data is to be read-cached (Yes in step S19), the flow proceeds to step S20. In step S20, the read control unit 22 instructs the third access unit 16 to acquire cache destination information serving as the write destination of the data read from the second storage medium 18. The third access unit 16 reads the instructed information from the information stored in the management information storage unit 19 and sends the read information to the read control unit 22. The read control unit 22 acquires the cache destination information serving as the write destination of the data read from the second storage medium 18 from the third access unit 16.

In step S21, the read control unit 22 instructs the first access unit 14 to write the data read from the second storage medium 18 to an area corresponding to the acquired cache destination information according to the second recording method. The first access unit 14 writes the instructed data to the instructed area of the first storage medium 17 according to the second recording method.

In step S22, the read control unit 22 instructs the third access unit 16 so that the cache address information AJ corresponding to the converted logical address indicates the write destination of the data read from the second storage medium 18. The third access unit 16 writes the instructed information to the area that is instructed by the information stored in the management information storage unit 19.

In step S23, the read control unit 22 may instruct the third access unit 16 to update the management information stored in the management information storage unit 19 in order to update a data hit ratio or the like as necessary. The third access unit 16 writes the instructed information to the area that is instructed by the information stored in the management information storage unit 19.

In step S24, the read control unit 22 sends the data read from the first storage medium 17 or the data read from the second storage medium 18 to the host interface unit 12. Upon receiving the data from the read control unit 22, the host interface unit 12 sends the received data to the host 20.

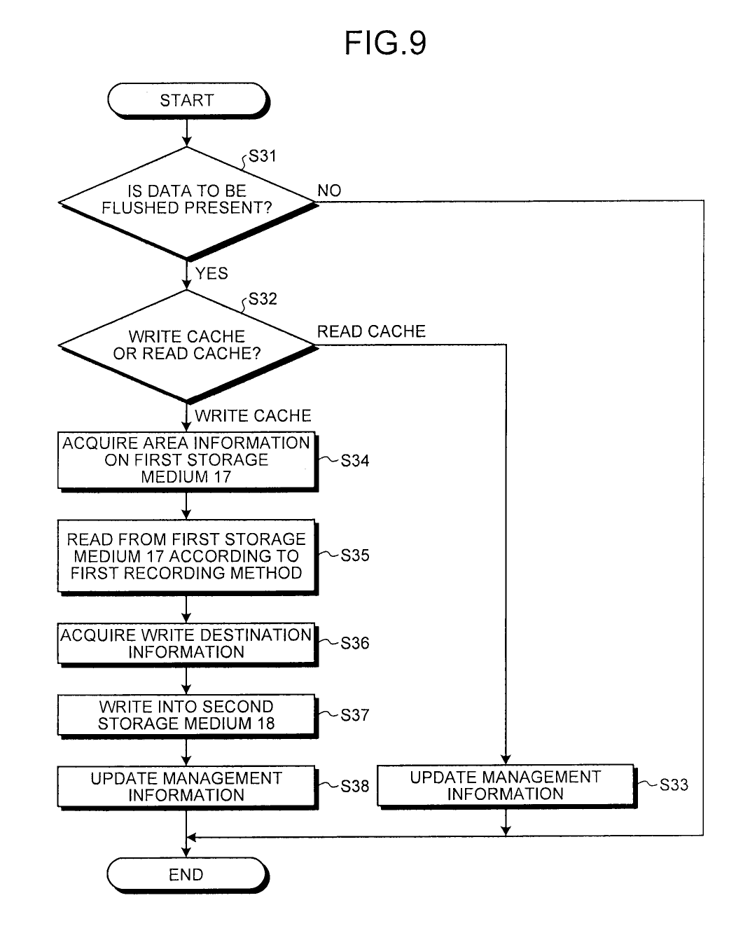

FIG. 9 is a flowchart illustrating a flush process of the data storage device according to the first embodiment.

In FIG. 9, in step S31, the flush control unit 23 determines whether data to be flushed from the cache is present at a predetermined timing or a dynamically determined timing. If “No” in step S31 is established, that is, when it is determined that data to be flushed from the cache is not present, the process ends.

When it is determined that data to be flushed from the cache is present (Yes in step S31), the flow proceeds to step S32. In step S32, the flush control unit 23 determines whether the flush target data is read cache data or write cache data.

When it is determined in step S32 that the flush target data is read cache data, the flow proceeds to step S33. In step S33, the flush control unit 23 instructs the third access unit 16 to update the on-cache presence flag information FJ corresponding to the flush target data with information indicating that data is not present as a cache. The third access unit 16 writes the instructed information to an area that is instructed by the information stored in the management information storage unit 19. When step S33 ends, the process ends.

When it is determined in step S32 that the flush target data is write cache data, the flow proceeds to step S34. In step S34, the flush control unit 23 instructs the third access unit 16 to read the cache destination information corresponding to the flush target data. The third access unit 16 reads the instructed information from the information stored in the management information storage unit 19 and sends the read information to the flush control unit 23. The flush control unit 23 acquires the cache destination information.

In step S35, the flush control unit 23 instructs the first access unit 14 to read data from the area indicated by the acquired cache destination information according to a method of reading data recorded according to the first recording method. The first access unit 14 reads the instructed data from the instructed area of the first storage medium 17 according to the method of reading data recorded according to the first recording method and sends the read data to the flush control unit 23. The flush control unit 23 acquires the read data.

In step S36, the flush control unit 23 instructs the third access unit 16 to acquire track number information and sector number information serving as the write destination of the read data. The third access unit 16 reads the instructed information from the information stored in the management information storage unit 19 and sends the read information to the flush control unit 23. The flush control unit 23 acquires the track number information and the sector number information serving as the write destination of the read data from the third access unit 16.

In step S37, the flush control unit 23 instructs the second access unit 15 to write the read data to the area corresponding to the acquired track number information and sector number information. The second access unit 15 writes the instructed data to the instructed area of the second storage medium 18.

In step S38, the flush control unit 23 instructs the third access unit 16 to write the acquired track number information and sector number information to the second storage medium physical address information that corresponds to the storage device address information corresponding to the flush target data. The third access unit 16 writes the instructed information to the area that is instructed by the information stored in the management information storage unit 19.

Moreover, the flush control unit 23 updates the on-cache presence flag information FJ corresponding to the flush target data with information indicating that data is not present as a cache. The third access unit 16 writes the instructed information to an area that is instructed by the information stored in the management information storage unit 19.

That is, as described above, the write cache can improve the reliability of the first storage medium 17 by recording write data into the first storage medium 17 according to the first recording method. Moreover, the read cache can increase the memory capacity without decreasing the reliability of the entire data storage device by recording read data into the first storage medium 17 according to the second recording method. As a result, it is possible to improve a cache hit ratio and to accelerate data access.

### Second Embodiment

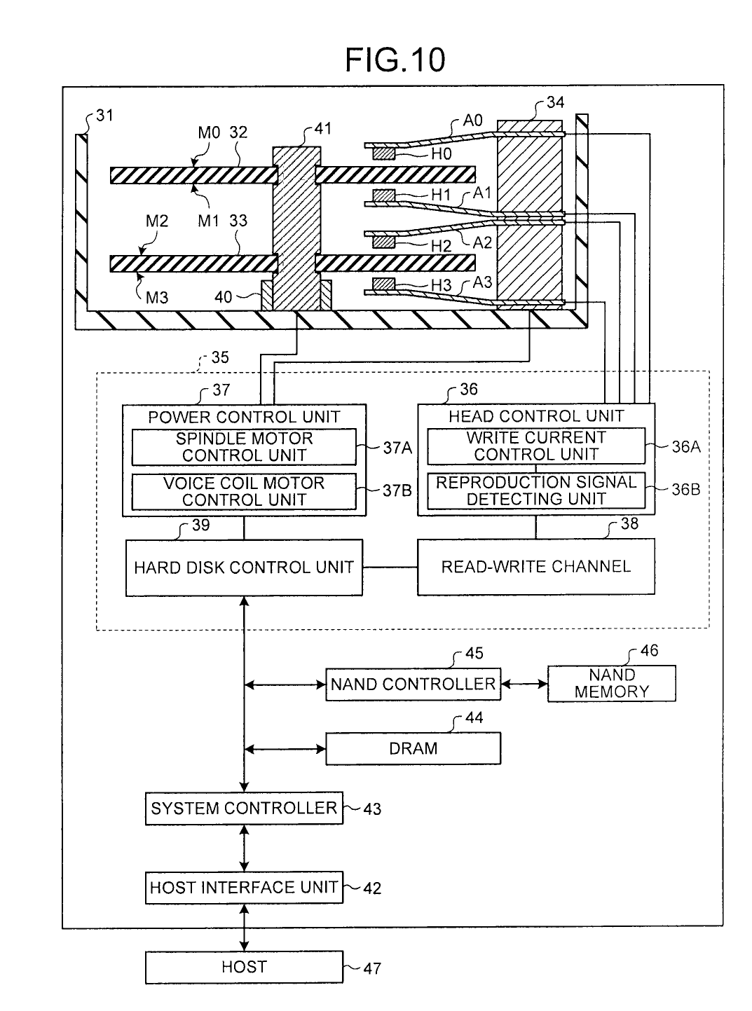

FIG. 10 is a block diagram illustrating an overall configuration of a data storage device according to the second embodiment.

In FIG. 10, the data storage device includes a plurality of magnetic disks 32 and 33. Disk surfaces M0 and M1 are formed on both surfaces of the magnetic disk 32, and disk surfaces M2 and M3 are formed on both surfaces of the magnetic disk 33. The magnetic disks 32 and 33 are integrally supported by a spindle 41.

In the data storage device, magnetic heads H0 to H3 are provided in the respective disk surfaces M0 to M3 so that the magnetic heads H0 to H3 are arranged so as to face the disk surfaces M0 to M3, respectively. Here, the magnetic heads H0 to H3 are held on the disk surfaces M0 to M3 with arms A0 to A3 interposed. The arms A0 to A3 can allow the magnetic heads H0 to H3 to slide within a horizontal plane.

Moreover, the data storage device includes a voice coil motor 34 that drives the arms A0 to A3 and a spindle motor 40 that rotates the magnetic disks 32 and 33 with the spindle 41 interposed. The magnetic disks 32 and 33, the magnetic heads H0 to H3, the arms A0 to A3, the voice coil motor 34, the spindle motor 40, and the spindle 41 are accommodated in a casing 31.

The data storage device includes a magnetic recording control unit 35, and the magnetic recording control unit 35 includes a head control unit 36, a power control unit 37, a read-write channel 38, and a hard disk control unit 39. The head control unit 36 includes a write current control unit 36A and a reproduction signal detecting unit 36B. The power control unit 37 includes a spindle motor control unit 37A and a voice coil motor control unit 37B.

The head control unit 36 amplifies signals during recording and reproduction. The write current control unit 36A controls write current flowing through the magnetic heads H0 to H3. The reproduction signal detecting unit 36B detects signals read by the magnetic heads H0 to H3. The power control unit 37 drives the voice coil motor 34 and the spindle motor 40. The spindle motor control unit 37A controls rotation of the spindle motor 40. The voice coil motor control unit 37B controls driving of the voice coil motor 34. The read-write channel 38 converts signals reproduced by the magnetic heads H0 to H3 into a data format that is handled by a host 47 and converts data output from the host 47 into a signal format that is recorded by the magnetic heads H0 to H3. Examples of such format conversion include DA conversion and encoding. Moreover, the read-write channel 38 decodes signals reproduced by the magnetic heads H0 to H3 and encodes the data output from the host 47. The hard disk control unit 39 can control recording and reproduction based on instructions from a system controller 43 and exchange data between the system controller 43 and the read-write channel 38.

Moreover, the data storage device includes a host interface unit 42, the system controller 43, a DRAM 44, a NAND controller 45, and a NAND memory 46. The host interface unit 42 can receive a command including a write command and a read command from the host 47 and output read data that is read from the magnetic disks 32 and 33 or the NAND memory 46 to the host 47. The host interface unit 42 is connected to the host 47. The host 47 may be a personal computer that issues a write instruction and a read instruction to a magnetic disk device and may be an external interface.

Although the NAND memory 46 provides a smaller number of rewritable times than the magnetic disks 32 and 33, the NAND memory 46 provides more excellent random access performance than the magnetic disks 32 and 33. Here, the NAND memory 46 is used as the caches of the magnetic disks 32 and 33. The NAND memory 46 can be used as the first storage medium 17 of FIG. 1, and the magnetic disks 32 and 33 can be used as the second storage medium 18 of FIG. 1.

The NAND controller 45 can control the NAND memory 46. Examples of the control of the NAND memory 46 include read-write control of the NAND memory 46, block selection, error correction, wear leveling, and the like.

The DRAM 44 can be used as a buffer for transmitting read data that is read from the NAND memory 46 to the host 47 and receiving write data written to the NAND memory 46 from the host 47.

The system controller 43 sends an instruction for writing and reading data to and from the magnetic disks 32 and 33 to the hard disk control unit 39 and sends an instruction for writing and reading data to and from the NAND memory 46 to the NAND controller 45. Here, the system controller 43 allows write data to be recorded into the NAND memory 46 according to the first recording method and allows the read data that is read from the magnetic disks 32 and 33 to be recorded into the NAND memory 46 according to the second recording method that provides lower reliability than the first recording method. The system controller 43, the read-write channel 38, the hard disk control unit 39, the host interface unit 42, and the NAND controller 45 can be configured as a system on-chip (SoC), for example. The process of the system controller 43 can be realized by firmware that is executed by a CPU. Moreover, the system controller 43 manages data recorded according to the first or second recording method, and the management information of FIG. 1 is held in the DRAM 44.

Moreover, any one of the methods illustrated in FIGS. 3A to 6C, for example, can be used as the first and second recording methods. The read-write process according to the first and second recording methods may be performed by the NAND controller 45.

When data is written and read to and from the magnetic disks 32 and 33, a signal is read from any one of the disk surfaces M0 to M3 by any one of the magnetic heads H0 to H3 while the magnetic disks 32 and 33 are rotated by the spindle motor 40, and the read signal is detected by the reproduction signal detecting unit 36B. The signal detected by the reproduction signal detecting unit 36B is converted into data by the read-write channel 38, and then, the data is sent to the hard disk control unit 39. The hard disk control unit 39 performs tracking control on any one of the magnetic heads H0 to H3 based on a burst pattern that is included in the signal detected by the reproduction signal detecting unit 36B. Moreover, the present position of any one of the magnetic heads H0 to H3 is calculated based on sector/cylinder information that is included in the signal detected by the reproduction signal detecting unit 36B, and seek control is performed so that the magnetic heads H0 to H3 approach a target position.

On the other hand, when data is written to the NAND memory 46, the NAND controller 45 may temporarily store write data supplied from the host 47 in the DRAM 44. The NAND controller 45 transmits the write data stored in the DRAM 44 to the NAND memory 46 and writes the write data to the NAND memory 46.

Moreover, when data is read from the NAND memory 46, the NAND controller 45 may read the read data from the NAND memory 46 and may temporarily store the read data in the DRAM 44. The NAND controller 45 transmits the read data stored in the DRAM 44 to the host 47.

Here, when the system controller 43 receives a write instruction from the host 47, the system controller 43 determines whether write data designated by the write instruction is to be cached into the NAND memory 46. When the write data is to be cached, the system controller 43 instructs the NAND controller 45 to record the write data into the NAND memory 46 according to the first recording method. On the other hand, when the write data is not to be cached, the system controller 43 instructs the hard disk control unit 39 to record the write data into the magnetic disks 32 and 33.

On the other hand, when the system controller 43 receives a read instruction from the host 47, the system controller 43 determines whether read data designated by the read instruction is present in a cache. When the read data designated by the read instruction is not present in the cache, the system controller 43 instructs the hard disk control unit 39 to read the read data from the magnetic disks 32 and 33. Moreover, the system controller 43 determines whether the read data that is read from the magnetic disks 32 and 33 is to be cached. When the read data is to be cached, the system controller 43 instructs the NAND controller 45 to record the read data into the NAND memory 46 according to the second recording method.

That is, as described above, when the data storage device receives a write command from the host 47, write data that is to be written according to the write command is not recorded in the magnetic disks 32 and 33. Thus, a write cache can improve reliability of the NAND memory 46 by recording write data into the NAND memory 46 according to the first recording method. On the other hand, when the data storage device receives a read command from the host 47, and data recorded in the magnetic disks 32 and 33 is written to the NAND memory 46, the read data that is read according to the read command is recorded in both the NAND memory 46 and the magnetic disks 32 and 33. Thus, even when the read data recorded in the NAND memory 46 is destroyed after the read data is recorded into the NAND memory 46, the read data can be read from the magnetic disks 32 and 33 again. Thus, a read cache can increase memory capacity without decreasing reliability of the entire data storage device. As a result, it is possible to improve a cache hit ratio and to accelerate data access.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage device comprising:
a first storage medium;
a second nonvolatile storage medium; and
a controller that allows write data requested to be written from a host device to be recorded into the first storage medium which is a cache memory of the second storage medium according to a first recording method and allows read data read from the second storage medium to be recorded into the first storage medium according to a second recording method that provides lower reliability but larger memory capacity than the first recording method.

2. The data storage device of claim 1, wherein
the controller comprises:
a write control unit that allows the write data to be recorded into the first storage medium according to the first recording method in response to a write request; and
a read control unit that allows read data read from the second storage medium to be recorded into the first storage medium according to the second recording method in response to a read request.

3. The data storage device of claim 2, wherein
the controller comprises:
a flush control unit that allows the write data to be read from the first storage medium and to be recorded into the second storage medium in response to a flush request.

4. The data storage device of claim 1, wherein
the first recording method uses an error correction code having a larger bit length for user data having the same bit length than the second recording method.

5. The data storage device of claim 1, wherein
the first recording method uses a smaller amount of data serving as a generation source of parity data than the second recording method.

6. The data storage device of claim 1, wherein
the first recording method allocates parity data to a predetermined amount of data, and the second recording method does not allocate parity data to the data.

7. The data storage device of claim 1, wherein
the first recording method uses a smaller amount of data serving as a generation source of a RS code than the second recording method.

8. The data storage device of claim 1, wherein
the first recording method allocates a RS code to a predetermined amount of data, and the second recording method allocates parity data to the predetermined amount of data.

9. The data storage device of claim 1, wherein
the first recording method allocates a RS code to a predetermined amount of data, and the second recording method does not allocate a RS code to the data.

10. The data storage device of claim 1, wherein
the first recording method uses a smaller number of bits stored per memory cell than the second recording method.

11. A storage controller configured to allow write data to be recorded into a first storage medium according to a first recording method and to allow read data read from a second nonvolatile storage medium to be recorded into the first storage medium according to a second recording method that provides lower reliability but larger memory capacity than the first recording method.

12. The storage controller of claim 11, comprising:
a write control unit that allows the write data to be recorded into the first storage medium according to the first recording method in response to a write request; and
a read control unit that allows read data read from the second storage medium to be recorded into the first storage medium according to the second recording method in response to a read request.

13. A data storage control method comprises: allowing write data to be recorded into a first storage medium according to a first recording method and allowing read data read from a second nonvolatile storage medium to be recorded into the first storage medium according to a second recording method that provides lower reliability but larger memory capacity than the first recording method.

14. The data storage control method of claim 13, wherein
the first recording method uses an error correction code having a larger bit length for user data having the same bit length than the second recording method.

15. The data storage control method of claim 13, wherein
the first recording method uses a smaller amount of data serving as a generation source of parity data than the second recording method.

16. The data storage control method of claim 13, wherein
the first recording method allocates parity data to a predetermined amount of data, and the second recording method does not allocate parity data to the data.

17. The data storage control method of claim 13, wherein
the first recording method uses a smaller amount of data serving as a generation source of a RS code than the second recording method.

18. The data storage control method of claim 13, wherein
the first recording method allocates a RS code to a predetermined amount of data, and the second recording method allocates parity data to the predetermined amount data.

19. The data storage control method of claim 13, wherein
the first recording method allocates a RS code to a predetermined amount of data, and the second recording method does not allocate a RS code to the data.

20. The data storage control method of claim 13, wherein
the first recording method uses a smaller number of bits stored per memory cell than the second recording method.
